(19) United States
(12) Patent Application Publication
(10) Pub. No.: US 2026/0310700 A1
(43) Pub. Date: Oct. 8, 2026

(54) EDUCATIONAL APPARATUS, EDUCATIONAL METHOD, AND RECORDING MEDIUM

(71) Applicant: BOND Co., Ltd., Kitakyushu-shi, Fukuoka (JP)

(72) Inventor: Hiromi FURUKAWA, Fukuoka (JP)

(21) Appl. No.: 18/879,183

(22) PCT Filed: Apr. 10, 2023
(86) PCT No.: PCT/JP2023/014570

§ 371 Date: Dec. 26, 2024

(30) Foreign Application Priority Data
Jun. 30, 2022 (JP) 2022-106341

(51) Int. Cl. G06F 16/3332; G06F 16/338

(52) U.S. Cl. CPC G06F 16/3334; G06F 16/338

(57) ABSTRACT

An educational apparatus and others can deliver a search result from a database to a user. An educational apparatus (1) delivers a search result from a database unit (5) to a user. The educational apparatus (1) includes a keyword processor (11) that analyzes state data input by the user to generate a keyword, the database unit (5) that performs a search using search keyword data included in the keyword and obtains state search-result data, a thesaurus processor (13) that replaces, with another word, at least part of expression keyword data included in the keyword, an expression adjuster (15) that generates expression adjustment data using processed expression keyword data resulting from replacement performed by the thesaurus processor (13), and a delivery controller (17) that delivers, from an output unit (19), the state search-result data using the expression adjustment data.

### FIELD

The present invention relates to an educational apparatus, an educational method, and a recording medium, and more particularly, to an educational apparatus that delivers a search result from a database unit to a user.

### BACKGROUND

The applicant has been involved in research and development for systems that create programs using information input by creators as described in, for example, Patent Literatures 1 and 2.

### CITATION LIST

### Patent Literature

Patent Literature 1: Japanese U.S. Pat. No. 4,725,936

Patent Literature 2: Japanese U.S. Pat. No. 4,725,918

### BRIEF SUMMARY

### Technical Problem

FIG. 3 is a block diagram of an example known system with a database of expert knowledge. A user of this database inputs index data to search the database and obtains a search result. However, such a database search takes the user's knowledge about appropriate index words. Without a certain level of knowledge, an inexperienced user in particular may fail to obtain an appropriate search response. Such a search response may also lack sufficient information for any user to understand, and may be inconvenient to use.

FIG. 4 is a block diagram of an example known program creation system provided by the applicant. When the user inputs material data (e.g., characters, voice, or an image) as a material for creating a program, the material data is analyzed to generate analysis data associated with information to be expressed. An expression adjuster generates expression adjustment data for adjusting an expression. A delivery controller adjusts an expression using the expression adjustment data and outputs analysis data from an output unit. However, this system can generate an expression based on material data input by the user. For material data associated with the emotion of confusion that is input by the user, for example, the system may thus generate a program that directly reflects the emotion of confusion. This takes correction in, for example, providing expert knowledge to the user.

One or more aspects of the present invention are directed to an educational apparatus and others that can deliver a search result from a database to a user.

### Solution to Problem

An educational apparatus according to a first aspect of the present invention is an apparatus for delivering a search result from a database unit to a user. The apparatus includes a keyword processor, a thesaurus processor, an expression adjuster, a delivery controller, and a database unit. The keyword processor analyzes state data input by a user to generate a keyword. The database unit performs a search using search keyword data included in the keyword and obtains state search-result data. The thesaurus processor replaces, with another word, at least part of expression keyword data included in the keyword. The expression adjuster generates expression adjustment data using processed expression keyword data resulting from replacement performed by the thesaurus processor. The delivery controller adjusts an expression using the expression adjustment data and delivers, from an output unit, the state search-result data.

An educational apparatus according to a second aspect of the present invention is the apparatus according to the first aspect in which the database unit performs the search using index data input by the user separately from the state data and obtains index search-result data. The delivery controller adjusts an expression using the expression adjustment data and delivers, from the output unit, the state search-result data and the index search-result data.

An educational apparatus according to a third aspect of the present invention is the apparatus according to the first or second aspect in which the thesaurus processor replaces, with a same keyword, keywords used for different words corresponding to different emotions.

An educational apparatus according to a fourth aspect of the present invention is the apparatus according to any one of the first to third aspects further including an analyzer that identifies the user who has input the state data. The delivery controller adjusts the expression for the user and delivers the state search-result data.

An educational method according to a fifth aspect of the present invention is implementable with an educational apparatus for delivering a search result from a database unit to a user. The apparatus includes a keyword processor, a thesaurus processor, an expression adjuster, a delivery controller, and a database unit. The method includes analyzing, with the keyword processor, state data input by a user to generate a keyword, performing, with the database unit, a search using search keyword data included in the keyword and obtaining state search-result data, replacing, with the thesaurus processor, at least part of expression keyword data included in the keyword with another word, generating, with the expression adjuster, expression adjustment data using processed expression keyword data resulting from replacement performed in the replacing the at least part of expression keyword data, and adjusting, with the delivery controller, an expression using the expression adjustment data and delivering, from an output unit, the state search-result data.

An educational method according to a sixth aspect of the present invention is the method according to the fifth aspect in which the performing the search with the database unit includes performing the search using index data input by the user separately from the state data and obtaining index search-result data. The adjusting the expression with the distribution controller includes adjusting an expression using the expression adjustment data and delivering, from the output unit, the state search-result data and the index search-result data.

An educational method according to a seventh aspect of the present invention is the method according to the fifth or sixth aspect in which the replacing with the thesaurus processor includes replacing, with a same keyword, keywords used for different words corresponding to different emotions.

An educational method according to an eighth aspect of the present invention is the method according to any one of the fifth to seventh aspects further including identifying, with an analyzer included in the educational apparatus, the user who has input the state data. The adjusting the expression with the delivery controller includes adjusting the expression for the user and delivering the state search-result data.

A program according to a ninth aspect of the present invention causes a computer to function as the educational apparatus according to any one of the first to fourth aspects. A non-transitory computer-readable recording medium according to a tenth aspect of the present invention stores the program according to the ninth aspect.

### Advantageous Effects

The technique according to the aspects of the present invention provides an expression appropriate for providing, for example, expert knowledge to a user by delivering input state data processed through thesaurus processing and then adjusting its expression, before delivering analysis data obtained through a database search based on the state data input by the user.

### BRIEF DESCRIPTION OF DRAWINGS

FIG. 1 is a block diagram of an example educational system according to an embodiment of the present invention.

FIG. 2 is a flowchart of an example operation of the educational system in FIG. 1.

FIG. 3 is a block diagram of an example known system with a database of expert knowledge.

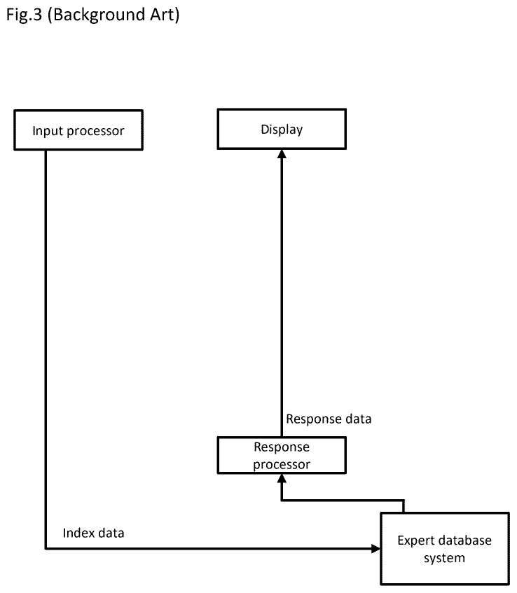

FIG. 4 is a block diagram of an example known program creation system.

### DETAILED DESCRIPTION

Embodiments of the present invention will now be described with reference to the drawings. The present invention is not limited to the embodiments.

### Embodiments

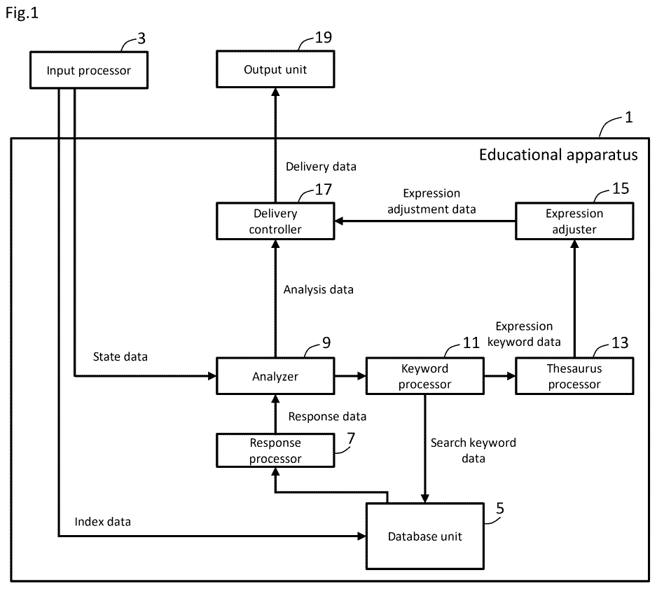

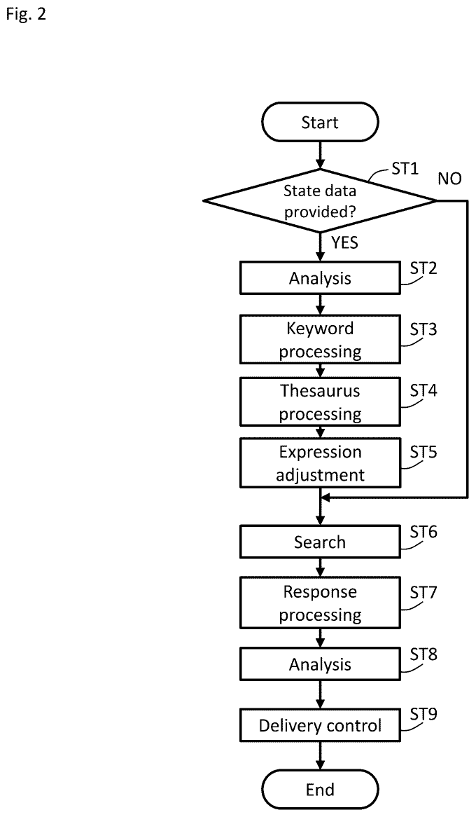

FIG. 1 is a block diagram of an example educational system according to an embodiment of the present invention. FIG. 2 is a flowchart of an example operation of the educational system in FIG. 1.

As shown in FIG. 1, the educational system includes an input processor 3, an output unit 19, and an educational apparatus 1.

The input processor 3 processes input from a user. The output unit 19 outputs information to the user. The input processor 3 and the output unit 19 may be implemented by the same device, such as a touchscreen with a camera. The input processor 3 and the output unit 19 may be implemented by different devices. For example, the input processor 3 may be implemented by a keyboard, a mouse, a camera, or another device, and the output unit 19 may be implemented by a speaker or a display.

The educational apparatus 1 may be implemented by, for example, a computer that operates under control of a program. The educational apparatus 1 delivers a search result from a database unit 5 to the user. The educational apparatus 1 includes an analyzer 9, a keyword processor 11, a thesaurus processor 13, an expression adjuster 15, a delivery controller 17, the database unit 5, and a response processor 7.

The database unit 5 may be implemented by, for example, a processor that operates under control of a program. The database unit 5 is a system with a database of typical expert knowledge (e.g., know-how) and allows a database search based on, for example, index data.

When the user inputs index data with the input processor 3, the database unit 5 performs a search using the index data to generate one or more sets of index search-result data. For example, the database unit 5 may search a database in an external server.

The user also inputs state data with the input processor 3. The state data includes at least one of character data, voice data, or image data (e.g., a still image and a moving image). When, for example, the user has no knowledge about a method for using a tool, the user captures an image of the tool with a camera and inputs the image data. Data indicating a specific scene in which the tool is used may be input as character data, voice data, or image data.

The index data includes, for example, a word appropriate for the database unit 5 to perform a search. The state data indicates the current state of the user. Thus, the index data differs from the state data. The index data may not be processed. Without the index data, the processing described below may be implemented in the same manner as the processing but without the index search-result data.

The analyzer 9 may be implemented by, for example, a processor that operates under control of a program. The analyzer 9 analyzes various sets of data. For example, the analyzer 9 analyzes the state data to generate data from which a keyword can be extracted. For example, the analyzer 9 extracts character strings from voice data to generate character data, or identifies an object captured in image data to generate data from which a keyword can be extracted. The analyzer 9 may also identify a person captured in the state data to identify a user.

The keyword processor 11 may be implemented by, for example, a processor that operates under control of a program. The keyword processor 11 extracts a keyword from the state data processed by the analyzer 9 to allow keyword extraction. The keyword includes expression keyword data and search keyword data. The expression keyword data and the search keyword data may be the same or different, or may be partially the same and partially different.

The database unit 5 performs a search using the search keyword data to generate multiple sets of state search-result data.

The response processor 7 may be implemented by, for example, a processor that operates under control of a program. The response processor 7 analyzes the index search-result data and the multiple sets of state search-result data, and adds feature data to each set of data. For example, to externalize and categorize implied knowledge, multiple determiners, or for example, multiple different processes using artificial intelligence (AI), may differently determine events to analyze the features of the index search-result data and the multiple sets of state search-result data. When, for example, knowledge about a cause of a trouble and a potential solution is to be retrieved, such causes and solutions can vary from, for example, common potential causes and solutions, causes and solutions that are less common but can cause serious errors, and to causes and solutions that are less common and can cause minor errors. The feature data is added to indicate the feature of knowledge obtained through the search. The feature data indicates, for example, the priority order for providing information to the user determined by comparing the determination results from AI. The response processor 7 may determine the priority order based on, for example, majority rules. Response data generated by the response processor 7 is a combination of index search-result data and feature data or a combination of each set of state search-result data and feature data.

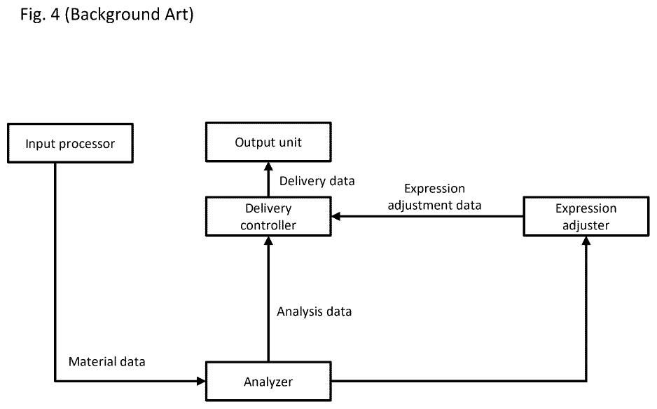

The analyzer 9 may be implemented by, for example, a processor that operates under control of a program. The analyzer 9 generates analysis data using information obtained by analyzing the state data as well as using the response data. This may be achieved by, for example, using new material data shown in FIG. 4 generated by adding response data to state data. Examples of the analysis data include character data, image data, and reader voice data for use in a delivery process. Examples of the analysis data include voice data for reading aloud the details of a question revealed based on state data. Examples further include data indicating a response to a question obtained by the response processor 7, such as voice data for reading aloud a response indicating the use of a tool or image data indicating the use of a tool. Further, the feature data is analyzed to preferentially select a response suited to the state of the user obtained from the state data. For an inexperienced user, for example, a common solution to a trouble is provided preferentially. For a supposedly knowledgeable user who is however confused and is asking a question, a trouble that is less common but can cause a serious error is handled preferentially over a common trouble.

The analyzer 9 may identify the user based on, for example, state data and login information. In this case, the analyzer 9 includes a user information determiner (not shown) that stores, for each user, user information including the user profile and the search history. For example, the analyzer 9 may transmit information about the user included in the user information determiner to the database unit 5, the response processor 7, or to both. The response processor 7 may then generate one or more sets of response data appropriate for the user. Multiple sets of response data may be presented to the user for selection. The analyzer 9 may also use information about the user included in the user information determiner to generate analysis data appropriate for the user. The analyzer 9 may also transmit information about the user included in the user information determiner to the expression adjuster 15. The expression adjuster 15 may then generate expression adjustment data appropriate for the user. Known systems tend to prioritize expert knowledge accumulated in the database unit 5 and unidirectionally transmit high-priority expert knowledge to inexperienced users. In contrast, the educational apparatus 1 can generate response data including expert knowledge appropriate for the user, express response data as analysis data appropriate for the user using, for example, a character string, or adjust response data as appropriate for the user using expression adjustment data appropriate for the user. The educational apparatus 1 allows more appropriate expressions for the user, and thus can precisely adjust the response to the user as appropriate based on responses to the user accumulated in the user information determiner, in the analyzer 9, or in other components. In addition to merely transmitting knowledge to the user, this structure allows resonance with the user and allows the educational apparatus 1 to change and develop as the user is educated, and thus provides the user with an appropriate opportunity to think themselves and to be educated more.

The thesaurus processor 13 may be implemented by, for example, a processor that operates under control of a program. The thesaurus processor 13 uses, in response to expression keyword data, a thesaurus of words associated with the emotion of calmness for evaluation suitable for words. The response is to be an expression to increase the calmness of the user rather than to resonate with their emotions. For example, the thesaurus processor 13 replaces keywords used for different words corresponding to different emotions with the same keyword. This allows the user to communicate calmly in any of various situations.

The expression adjuster 15 may be implemented by, for example, a processor that operates under control of a program. The expression adjuster 15 analyzes processed keyword data that has been processed by the thesaurus processor 13 and generates expression adjustment data for adjusting an expression to be transmitted to the user. When, for example, a question about a method of using a tool is generated with state data including an expression with anger, the thesaurus processor 13 removes the anger from the expression of the question and generates processed expression keyword data indicating a question asked calmly for the method of using the tool. The expression adjuster 15 generates expression adjustment data that guides the user to a calm state (calmness) by adjusting the expression to calmly provide the method for using the tool based on the processed expression keyword data.

The delivery controller 17 may be implemented by, for example, a processor that operates under control of a program. The delivery controller 17 outputs analysis data from the output unit 19. The output includes at least characters, voice, or an image. The voice may be expressed using, for example, an animation character. The delivery controller 17 uses expression adjustment data to adjust the expression before outputting the analysis data.

An example operation of the educational system in FIG. 1 will now be described with reference to FIG. 2.

Data input by the input processor 3 is provided to the analyzer 9 and the database unit 5. The analyzer 9 determines whether index data alone has been provided from the input processor 3 (step ST1).

When receiving index data alone and receiving no state data from the input processor 3 (No in step ST1), the analyzer 9 does not perform processing associated with state data, and the database unit 5 performs a search using the index data (step ST6). The response processor 7 then processes the search result to generate response data (step ST7). The analyzer 9 analyzes the response data to generate analysis data (step ST8). The delivery controller 17 outputs the analysis data from the output unit 19 (step ST9).

When receiving state data from the input processor 3 (Yes in step ST1), the analyzer 9 performs the processing associated with the state data. The analyzer 9 analyzes the state data to generate data from which a keyword can be extracted (step ST2). The keyword processor 11 extracts keyword data indicating a keyword (step ST3). The thesaurus processor 13 performs processing to replace the keyword included in the keyword data with another word using the thesaurus to generate processed expression keyword data (step ST4). The expression adjuster 15 analyzes the processed expression keyword data that has been processed by the thesaurus processor 13 to generate expression adjustment data for adjusting the expression to be transmitted to the user (step ST5).

In step ST6, when receiving state data alone and receiving no index data from the input processor 3, the database unit 5 performs a search using search keyword data included in the keyword data. When receiving both state data and index data from the input processor 3, the database unit 5 performs a search using both the index data and the search keyword data.

The response processor 7 processes the search result to generate response data (step ST7). The analyzer 9 analyzes the response data to generate analysis data (step ST8). The delivery controller 17 outputs the analysis data from the output unit 19 (step ST9).

### REFERENCE SIGNS LIST

1 Educational apparatus
3 Input processor
5 Database unit
7 Response processor
9 Analyzer
11 Keyword processor
13 Thesaurus processor
15 Expression adjuster
17 Delivery controller
19 Output unit

1. An educational apparatus for delivering a search result from a database unit to a user, the apparatus comprising:
a keyword processor configured to analyze state data input by a user to generate a keyword;
a database unit configured to perform a search using search keyword data included in the keyword and obtain state search-result data;
a thesaurus processor configured to replace, with another word, at least part of expression keyword data included in the keyword;
an expression adjuster configured to generate expression adjustment data using processed expression keyword data resulting from replacement performed by the thesaurus processor; and
a delivery controller configured to adjust an expression using the expression adjustment data and deliver, from an output unit, the state search-result data.

2. The educational apparatus according to claim 1, wherein
the database unit performs the search using index data input by the user separately from the state data and obtains index search-result data, and
the delivery controller adjusts an expression using the expression adjustment data and delivers, from the output unit, the state search-result data and the index search-result data.

3. The educational apparatus according to claim 1, wherein
the thesaurus processor replaces, with a same keyword, keywords used for different words corresponding to different emotions.

4. The educational apparatus according to claim 1, further comprising:
an analyzer configured to identify the user who has input the state data,
wherein the delivery controller adjusts the expression for the user and delivers the state search-result data.

5. An educational method implementable with an educational apparatus for delivering a search result from a database unit to a user, the apparatus including a keyword processor, a thesaurus processor, an expression adjuster, a delivery controller, and a database unit, the method comprising:
analyzing, with the keyword processor, state data input by a user to generate a keyword;
performing, with the database unit, a search using search keyword data included in the keyword and obtaining state search-result data;
replacing, with the thesaurus processor, at least part of expression keyword data included in the keyword with another word;
generating, with the expression adjuster, expression adjustment data using processed expression keyword data resulting from replacement performed in the replacing the at least part of expression keyword data; and
adjusting, with the delivery controller, an expression using the expression adjustment data and delivering, from an output unit, the state search-result data.

6. The educational method according to claim 5, wherein
the performing the search with the database unit includes performing the search using index data input by the user separately from the state data and obtaining index search-result data, and
the adjusting the expression with the distribution controller includes adjusting an expression using the expression adjustment data and delivering, from the output unit, the state search-result data and the index search-result data.

7. The educational method according to claim 5, wherein
the replacing with the thesaurus processor includes replacing, with a same keyword, keywords used for different words corresponding to different emotions.

8. The educational method according to claim 5, further comprising:
identifying, with an analyzer included in the educational apparatus, the user who has input the state data,
wherein the adjusting the expression with the delivery controller includes adjusting the expression for the user and delivering the state search-result data.

9. A non-transitory computer readable recording medium storing a program for causing a computer to function as the educational apparatus according to claim 1.
